(19) United States
(12) Patent Application Publication
(10) Pub. No.: US 2020/0079958 A1
(43) Pub. Date: Mar. 12, 2020

(54) POLYURETHANE FORMULATIONS FOR THE PRODUCTION OF COMPOSITE ELEMENTS

(71) Applicant: BASF SE, Ludwigshafen am Rhein (DE)

(72) Inventors: Roland Hinrich Staff, Ludwigshafen (DE); Julia Goeschel, Lemfoerde (DE); Li Zhang, Shanghai (CN)

(21) Appl. No.: 16/492,114

(22) PCT Filed: Mar. 7, 2018
(86) PCT No.: PCT/EP2018/055534

§ 371 Date: Sep. 7, 2019

(30) Foreign Application Priority Data
Mar. 9, 2017 (CN) PCT/CN2017/076024

(51) Int. Cl. C08L 75/08; C08G 18/48; C08G 18/24; C08G 18/76; C08G 18/08; C08J 5/04

(52) U.S. Cl. CPC C08L 75/08; C08J 2433/12; C08G 18/4845; C08G 18/4816; C08G 18/246; C08G 18/7664; C08G 18/0838; C08J 5/046; C08L 2205/20; C08L 2205/16; C08L 2205/03; C08L 2205/025; C08J 2375/08; C08J 2475/04; C08G 18/4829

(57) ABSTRACT

The present invention relates to a process for the production of a polyurethane reinforced composite including mixing (A) a Polyisocyanate component including di- or Polyisocyanates (a) and (B) a polyol component including compounds having at least two groups reactive toward isocyanates (b), catalyst (c) and optionally further additives, to form a reaction mixture, contacting the reaction mixture with the reinforcing material at temperatures of less than 100° C. and curing the reaction mixture at temperatures of more than 100° C. to form a polyurethane reinforced composite. The catalyst (c) includes microencapsulated polyurethane catalyst which includes a capsule core, containing polyurethane catalyst, and an acrylic copolymer capsule shell. An average particle size D(0,5) of the microcapsules is 1 to 50 μm. The invention further relates to a polyurethane reinforced composite obtainable by a process according to the invention.

The present invention relates to a process for the production of a polyurethane reinforced composite comprising mixing a (A) a Polyisocyanate component comprising di- or Polyisocyanates (a) and (B) a polyol component comprising compounds having at least two groups reactive toward isocyanates (b), catalyst (c) and optionally further additives, to form a reaction mixture, contacting the reaction mixture with the reinforcing material at temperatures of less than 100° C. and curing the reaction mixture at temperatures of more than 100° C. to form a polyurethane reinforced composite, wherein the catalyst (c) comprises microencapsulated polyurethane catalyst which comprises a capsule core, containing polyurethane catalyst, and an acrylic copolymer capsule shell and wherein the average particle size D(0,5) of the microcapsules is 1 to 50 μm. The invention further relates to a polyurethane reinforced composite obtainable by a process according to the invention.

Polyurethane fiber reinforced composites are well known and include composites produced by vacuum infusion, filament winding and pultrusion. In these applications the fiber material is wetted with a polyurethane reaction mixture, for example in an impregnation bath or an impregnation box. Thereafter the impregnated fiber material is brought into its final shape and the polyurethane reaction mixture is cured, for example in an oven.

This procedure is very demanding for polyurethane based resins since it requires a fast curing once the fiber material is in its final shape but on the other side a long open time to prevent clogging of the impregnation bath. This is especially true for the pultrusion process. In this continuous process, fiber reinforced profiles with a constant cross section are produced. A pultrusion plant is typically composed of an impregnation unit and of a heated die, and also of a takeoff system, which is responsible for the continuity of the process. The impregnation of the fibers takes place in an open bath or in a closed injection box. Here, the reinforcement material, for example glassfiber rovings or glassfiber mats, is wetted with the resin. The composite is then shaped and hardened in the heated die. A take-off system draws the finished profile out of the die, and it is finally cut to the desired lengths. To maximize the efficiency of the pultrusion process, it is desirable to use high process speeds, while at the same time the pultrudate has very good mechanical properties and high surface quality.

Bayer, Huntsman, Milgard Manufacturing Incorporated, Resin Systems Inc., and others have described the use of two-component polyurethane systems for the pultrusion process. The materials used are mainly polyether polyols having functionality of 3.0, these being reacted with isocyanates, often polymeric MDI, in the presence of amines and, respectively, metal complexes as catalysts, and also of various additives. This makes it even more demanding to find a catalyst system which guaranties a low viscosity and long open time during wetting and on the other hand a fast and complete curing.

In WO 2005/049301, Huntsman counters this problem by using two metal catalysts. Bayer uses systems based on DMC polyols (US 2008/0090921) or on graft polyols (US 2008/0087373), or uses immiscible PU systems (US 2008/0090996). Both Bayer and Huntsman moreover mention the principle of use of acids for partial neutralization, i.e. blocking, of the amine catalysis. Specific examples mentioned in WO 2005038118 are formic acid, acetic acid, 2-ethylhexanoic acid, and oleic acid. It has been found that acid blockage of catalysts results in additional drawbacks like high pull-off forces and the formation of a rough surface of the finished profile.

Attempts have already been made to encapsulate polyaddition catalysts, thereby delaying the release of the catalysts, with rapid through-curing taking place only when the catalyst is released. Through the nature of the capsules in terms of size, type and thickness of walls, etc., it is possible to define and optimize the time prior to release—that is, the open time.

U.S. Pat. No. 6,224,793 discloses an active agent encapsulated in a crystallizable or thermoplastic polymer wherein the particle size of the encapsulated active agent is 3,000 microns or less wherein the active agent is not significantly extractable from the particles under ambient conditions. Crystallizable polymer has the disadvantage that the production process is very complex by melting the polymer at 125° C. and spinning the molten polymer at 15 000 rpm to form particles.

US 200501563862 discloses a controlled release system comprising a wide range of effectively encapsulated active ingredients and sensory markers. Release is triggered in response to moisture or over an extended period of time. Moisture release is not applicable for release in polyurethane systems for filament winding or pulltrusion.

Adv. Mater. 2016, DOI: 10.100²/adma.201600830 describes the production of thermolatent catalyst nanocapsules. The capsule core consists of isooctane and dimethyltin neodecanoate, the capsule shell of poly(methyl methacrylate-co-butyl methacrylate-co-methacrylic acid) which is crosslinked via butanediol dimethacrylate. The capsules are produced by a miniemulsion technique. The only stimulus described for the release of catalyst is the thermal opening triggered by an expansion agent. Disadvantage here is the low shelf stability. After only about two weeks storage of the capsules, the reaction profile has noticeably changed.

Generally, the polyurethane reaction mixture is obtained by the two component process wherein a polyol component, comprising compounds reactive towards isocyanates as well as additives, like catalysts and processing agents, is reacted with an isocyanate component comprising isocyanates. These components have to show a certain shelf stability and may not demix or change reaction parameters during storage.

It has been object of the present invention to provide a process for the production of a polyurethane fiber reinforced composite which allows long open time and low viscosities of the polyurethane reaction mixture during impregnation and a fast curing. Further, it is desired that the predefined polyol component as well as the isocyanate component show a certain storage stability of preferably several months without demixing or changes in the reaction profile.

Surprisingly, it has been found that the object of the invention is achieved by a process for the production of a polyurethane reinforced composite comprising mixing a (A) a Polyisocyanate component comprising di- or Polyisocyanates (a) and (B) a polyol component comprising compounds having at least two groups reactive toward isocyanates (b), catalyst (c) and optionally further additives, to form a reaction mixture, contacting the reaction mixture with the reinforcing material at temperatures of less than 100° C. and curing the reaction mixture at temperatures of more than 100° C. to form a polyurethane reinforced composite, wherein the catalyst (c) comprises microencapsulated polyurethane catalyst which comprises a capsule core, containing polyurethane catalyst, and an acrylic copolymer capsule shell and wherein the average particle size D(0,5) of the microcapsules is 1 to 50 μm. The invention further relates to a polyurethane reinforced composite obtainable by a process according to the invention.

In a process according to the invention comprises the step of wetting the reinforcing material as honeycomb material or fibers temperatures of less than 100° C., as room temperature, and curing the reinforced part at elevated temperatures of more than 100° C. These processes comprise the well known processes as vacuum infusion process, filament winding process and pultrusion process. In a preferred embodiment of the present invention the process for the production of a polyurethane fiber reinforced composite is a process comprising the step of impregnating the fibers in an impregnation bath, like filament winding process or more preferably a pultrusion process. These processes are well known in the art.

The process of filament winding generally involves winding filaments under tension over a rotating mandrel. The mandrel rotates around the spindle while a delivery eye traverses horizontally in line with the axis of the rotating mandrel, laying down fibers in the desired angle. The filaments, often glass fibers of carbon fibers, optionally in form of rovings or fiber mats, are impregnated in a resin bath with resin just before they are wound onto the mandrel. Once the mandrel is completely covered to the desired thickness, the resin is cured.

The pultrusion process is typically performed in a pultrusion plant which is composed of an impregnation unit and of a heated die, and also of a take-off system, which is responsible for the continuity of the process. The impregnation of the fibers takes place in an open bath or in a closed injection box. Here, the reinforcement material, for example glass- or carbonfiber rovings or mats, is wetted with the resin. The composite is then shaped and hardened in the heated die. A take-off system draws the finished profile out of the die, and it is finally cut to the desired lengths.

The di- or polyisocyanates (a) used can be any of the aliphatic, cycloaliphatic, or aromatic isocyanates known for producing polyurethanes. Examples are diphenylmethane 2,2′-, 2,4-, and 4,4′-diisocyanate, the mixtures of monomeric diphenylmethane diisocyanates and of diphenylmethane diisocyanate homologs having a greater number of rings (polymeric MDI), isophorone diisocyanate (IPDI) or its oligomers, tolylene diisocyanate (TDI), for example tolylene diisoyanate isomers such as tolylene 2,4- or 2,6-diisocyanate, or a mixture of these, tetramethylene diisocyanate or its oligomers, hexamethylene diisocyanate (HDI) or its oligomers, naphthylene diisocyanate (NDI), or a mixture thereof.

The di- or polyisocyanates (a) used preferably comprise isocyanates based on diphenylmethane diisocyanate, in particular comprising polymeric MDI. The functionality of the di- and polyisocyanates (a) is preferably from 2.0 to 2.9, particularly preferably from 2.1 to 2.8. The viscosity of the di- or polyisocyanates (a) at 25° C. to DIN 53019-1 to 3 here is preferably from 5 to 600 mPas and particularly preferably from 10 to 300 mPas.

Di- and polyisocyanates (a) can also be used in the form of polyisocyanate prepolymers. These polyisocyanate prepolymers are obtainable by reacting an excess of the polyisocyanates described above (constituent (a-1)) with compounds (constituent (a-2)) having at least two groups reactive toward isocyanates, for example at temperatures of from 30 to 100° C., preferably at about 80° C., to give the prepolymer. The NCO content of polyisocyanate prepolymers of the invention is preferably from 20 to 33% by weight of NCO, particularly preferably from 25 to 32% by weight of NCO.

Compounds (a-2) having at least two groups reactive toward isocyanates are known to the person skilled in the art and are described by way of example in “Polyurethane Handbook” HanserPublishers, 2^{nd} edition, 1993, chapter 3.1. Examples of compounds that can be used, having at least two groups reactive toward isocyanates, are therefore polyether- or polyesterols such as those described under (b) below. The compounds (a-2) used having at least two groups reactive toward isocyanates are preferably polyether- or polyesterols comprising secondary OH groups, an example being polypropylene oxide. The functionality of these polyether- or polyesterols is preferably from 2 to 4, particularly preferably from 2 to 3.

It is particularly preferable to use no polyisocyanate prepolymers.

The compounds (b) used having at least two groups reactive toward isocyanates, also termed “polyols” for the purposes of this invention, can comprise any of the compounds having at least two groups reactive toward isocyanates, examples being OH, SH, NH, NH₂, —COOH, and CH-acidic groups, where the proportion of secondary OH groups, based on the number of groups reactive toward isocyanates, is at least 50%, preferably at least 60%, particularly preferably at least 70%, and in particular at least 80%.

It is usual to use polyetherols and/or polyesterols having from 2 to 8 hydrogen atoms reactive toward isocyanate, and to use low-molecular-weight polyols, such as glycerol, dipropylene glycol, and/or tripropylene glycol. The OH number of these compounds is usually in the range from 30 to 2000 mg KOH/g, preferably in the range from 40 to 1000 mg KOH/g. The average OH number of all of the compounds (b) used here having at least two groups reactive toward isocyanates is from 100 to 1000 mg KOH/g, preferably from 300 to 900 mg KOH/g.

The polyetherols are obtained by known processes, for example via anionic polymerization of alkylene oxides with addition of at least one starter molecule comprising from 2 to 8, preferably from 2 to 6, and particularly preferably from 2 to 4, reactive hydrogen atoms, in the presence of catalysts. Catalysts used can comprise alkali metal hydroxides, such as sodium hydroxide or potassium hydroxide, or alkali metal alcoholates, such as sodium methoxide, sodium ethoxide, potassium ethoxide, or potassium isopropoxide, or, in the case of cationic polymerization, Lewis acids, such as antimony pentachloride, boron trifluoride etherate, or bleaching earth. Other catalysts that can be used are double-metal cyanide compounds, known as DMC catalysts.

The alkylene oxides used preferably comprise one or more compounds having from 2 to 4 carbon atoms in the alkylene moiety, e.g. tetrahydrofuran, ethylene oxide, propylene 1,2-oxide, butylene 1,2-oxide or butylene 2,3-oxide, in each case alone or in the form of a mixture, and preferably propylene 1,2-oxide and/or ethylene oxide, in particular propylene 1,2-oxide.

Examples of starter molecules that can be used are ethylene glycol, diethylene glycol, glycerol, trimethylolpropane, pentaerythritol, sugar derivatives, such as sucrose, hexitol derivatives, such as sorbitol, methylamine, ethylamine, isopropylamine, butylamine, benzylamine, aniline, toluidine, toluenediamine, naphthylamine, ethylenediamine, diethylenetriamine, 4,4′-methylenedianiline, 1,3-propanediamine, 1,6-hexanediamine, ethanolamine, diethanolamine, triethanolamine, and also other di- or polyhydric alcohols, or di- or polybasic amines.

The polyester alcohols used are mostly produced via condensation of polyhydric alcohols having from 2 to 12 carbon atoms, e.g. ethylene glycol, diethylene glycol, butanediol, trimethylolpropane, glycerol, or pentaerythritol, with polybasic carboxylic acids having from 2 to 12 carbon atoms, e.g. succinic acid, glutaric acid, adipic acid, suberic acid, azelaic acid, sebacic acid, decanedicarboxylic acid, maleic acid, fumaric acid, phthalic acid, isophthalic acid, terephthalic acid, and the isomers of naphthalenedicarboxylic acids, or their anhydrides.

Other starting materials that can also be used concomitantly in producing the polyesters are hydrophobic substances. The hydrophobic substances are substances insoluble in water which comprise a nonpolar organic moiety, and which also have at least one reactive group selected from hydroxy, carboxylic acid, carboxylic ester, or a mixture thereof. The equivalent weight of the hydrophobic materials is preferably from 130 to 1000 g/mol. Examples of materials that can be used are fatty acids, such as stearic acid, oleic acid, palmitic acid, lauric acid, or linoleic acid, and also fats and oils, e.g. castor oil, maize oil, sunflower oil, soybean oil, coconut oil, olive oil, or tall oil. If polyesters comprise hydrophobic substances, the proportion of the hydrophobic substances, based on the total monomer content of the polyester alcohol, is preferably from 1 to 30 mol %, particularly preferably from 4 to 15 mol %.

The functionality of the polyesterols used is preferably from 1.5 to 5, particularly preferably from 1.8 to 3.5.

In one particularly preferred embodiment, the compounds (b) having groups reactive toward isocyanates comprise polyetherols, in particular exclusively polyetherols. The actual average functionality of the polyetherols is preferably from 2 to 4, particularly preferably from 2.5 to 3.5, in particular from 2.8 to 3.2, and their OH number is preferably from 300 to 900 mg KOH/g, and their content of secondary OH groups is preferably at least 50%, with preference at least 60%, with particular preference at least 70% and in particular at least 80%. The polyetherol used here preferably comprises polyetherol based on based on glycerol as starter and on propylene-1,2-oxide.

The catalyst (c) comprises microencapsulated polyurethane catalyst which comprises a capsule core, containing polyurethane catalyst, and an acrylic copolymer capsule shell and wherein the average particle size D(0,5) of the microcapsules is 1 to 50 μm. The average particle size D(0,5) of the microcapsules used according to the invention (volume-weighted average, determined by means of light scattering) is preferably 1 to 50 μm, more preferably 1 to 20 μm, more particularly from 2 to 10 μm. D(0,5) here is defined as the particle diameter at which a cumulative particle volume of 50% is reached. Capsules with this diameter have sufficient mechanical stability to be able to be handled without damage and incorporated without damage into the compositions that are to be cured. The size is selected such that unintended breakage of individual capsules can be tolerated, since the unintended breakage of individual capsules releases only a small amount of polyurethane catalyst, not leading to the premature hardening of the compositions. On the other hand, a quantity of catalyst sufficient for complete curing is introduced by means of a readily manageable volume of capsules.

In certain embodiments the microencapsulated polyurethane catalyst takes the form of a dry powder, granules or agglomerate.

The weight ratio of capsule core to capsule shell is generally from 50:50 to 95:5, preferably from 60:40 to 94:6, especially preferably from 70:30 to 93:7.

The polyurethane catalyst can comprise any of the catalysts conventional for producing polyurethane. These catalysts are described by way of example in “Polyurethane Handbook” Carl Hanser Verlag, 2nd edition 1993, chapter 3.4.1. Examples of those that can be used here are organometallic compounds, such as complexes of tin, of zinc, of titanium, of zirconium, of iron, of mercury, or of bismuth, preferably organotin compounds, such as stannous salts of organic carboxylic acids, e.g. stannous acetate, stannous octoate, stannous ethylhexanoate, and stannous laurate, and the dialkyltin(IV) salts of carboxylic acids, e.g. dibutyltin diacetate, dibutyltin dilaurate, dibutyltzin maleate, and dioctyltin diacetate, and also phenylmercury neodecanoate, bismuth carboxylates, such as bismuth(III) neodecanoate, bismuth 2-ethylhexanoate, and bismuth octanoate, or a mixture. Other possible catalysts are basic amine catalysts. Examples of these are amidines, such as 2,3-dimethyl-3,4,5,6-tetrahydropyrimidine, tertiary amines, such as triethylamine, triethylenediamine, tributylamine, dimethylbenzylamine, N-methyl, N-ethyl, N-cyclohexylmorpholine, N,N,N′,N′-tetramethylethylenediamine, N,N,N′,N′-tetramethylbutanediamine, N,N,N′,N′-tetramethylhexanediamine, penta-methyldiethylenetriamine, tetramethyldiaminoethyl ether, bis(dimethylaminopropyl)urea, dimethylpiperazine, 1,2-dimethylimidazole, 1-azabicyclo[3.3.0]octane, and preferably 1,4-diazabicyclo[2.2.2]octane,1,8-diazabicyclo[5.4.0]-undecen-7-ene, and alkanolamine compounds, such as triethanolamine, triisopropanolamine, N-methyl- and N-ethyldiethanolamine, and dimethylethanolamine. The catalysts can be used individually or in the form of a mixture. Mixtures of metal catalysts and of basic amine catalysts are optionally used as catalysts (c). In a preferred embodiments polyurethane catalysts is tin based or bismuth based, for example the catalyst is selected from the group, consisting of dialkyltin(IV) salts of carboxylic acids, e.g. dibutyltin diacetate, dibutyltin dilaurate, dibutyltzin maleate, and dioctyltin diacetate, zinc(II) diacetate, zinc(II) dioctoate, zirconium acetylacetonate and zirconium 2,2,6,6-tetramethyl-3,5-heptanedionate and bismuth(III) neodecanoate, bismuth 2-ethylhexanoate, and bismuth octanoate or mixtures thereof. Especially preferred the polyurethane catalyst is selected from the group consisting of dibutyltin dilaurate, dioctyltin dilaurate, bismuth neodecanoate, bismuth dioctoate and bismuth ethylhexanoate or mixtures of two or more thereof.

The capsule core preferably comprises a hydrophobic core material as well as the polyurethane catalyst. The accompanying use of a hydrophobic core material allows the production of well-defined capsules of uniform size distribution and facilitates the distribution of the polymerization catalyst released in the application medium, as soon as the capsule shell has opened.

The polymerization catalyst accounts preferably for 10 to 100 wt %, e.g. 20 to 90 wt %, more particularly 30 to 70 wt %, based on the total weight of polymerization catalyst and hydrophobic core material.

Examples of hydrophobic core materials are aliphatic hydrocarbons, aromatic hydrocarbons, halogenated hydrocarbons, saturated or unsaturated C₆-C₃₀ fatty acids, fatty alcohols, oxo-process alcohols, ethers of fatty alcohols, C₆-C₃₀ fatty amines, fatty acid esters, triglycerides, esters of aliphatic or aromatic polycarboxylic acids, natural and synthetic waxes, and trialkylphosphoric esters. The hydrophobic core materials may also be used as mixtures of two or more substances.

Examples of suitable substances include the following:
aliphatic hydrocarbons, such as saturated or unsaturated C₁₀-C₄₀ hydrocarbons, which are branched or, preferably, linear, such as n-tetradecane, n-pentadecane, n-hexadecane, n-heptadecane, n-octadecane, n-nonadecane, n-eicosane, n-heneicosane, n-docosane, n-tricosane, n-tetracosane, n-pentacosane, n-hexacosane, n-heptacosane, n-octacosane and also cyclic hydrocarbons, e.g. cyclohexane, cyclooctane, cyclodecane;
aromatic hydrocarbons, such as benzene, naphthalene, biphenyl, o- or m-terphenyl, C₁-C₄₀ alkyl-substituted aromatic hydrocarbons such as dodecylbenzene, tetradecylbenzene, hexadecylbenzene, hexylnaphthalene or decylnaphthalene;
halogenated hydrocarbons such as chlorinated paraffin, bromoctadecane, bromopentadecane, bromononadecane, bromoeicosane, bromodocosane;
saturated or unsaturated C₆-C₃₀ fatty acids such as lauric, stearic, oleic or behenic acid;
fatty alcohols such as lauryl, stearyl, oleyl, myristyl and cetyl alcohol, mixtures such as coconut fatty alcohol, and also the oxo-process alcohols, which are obtained by hydroformylation of α-olefins and further reactions;
C₆-C₃₀ fatty amines, such as decylamine, dodecylamine, tetradecylamine or hexadecylamine;
fatty acid esters such as C₁-C₁₀ alkyl esters of fatty acids such as propyl palmitate, methyl stearate or methyl palmitate and also, preferably, their eutectic mixtures, or methylcinnamate;
triglycerides of linear and branched C₃-C₂₁ carboxylic acids, such as olive oil, soyabean oil, corn oil, cottonseed oil, sunflower oil, peanut oil, palm oil, coconut oil and wheat germ oil;
esters of aliphatic or aromatic polycarboxylic acids, especially esters of adipic acid, sebacic acid, succinic acid, citric acid, acetylcitric acid, cyclohexane-1,2-dicarboxylic acid or phthalic acid, such as di-2-ethylhexyl adipate, di-n-hexyl adipate, di-n-octyl adipate, diisooctyl adipate, di-n-decyl adipate, diisodecyl adipate, ethylhexyl sebacate, diisodecyl sebacate, di-n-butyl phthalate, di-n-octyl phthalate, di-n-hexyl phthalate, di-n-decyl phthalate, dicyclohexyl phthalate, diisodecyl phthalate, butyl cyclohexyl phthalate, diisooctyl phthalate, isooctyl isodecyl phthalate;
natural and synthetic waxes such as montanic acid waxes, montanic ester waxes, carnauba wax, polyethylene wax, oxidized waxes, polyvinyl ether waxes, ethylene-vinyl acetate wax or hard Fischer-Tropsch process waxes;
trialkylphosphoric esters, such as trimethyl phosphate.

Of these, esters of aliphatic or aromatic polycarboxylic acids, especially adipic esters, 1,2-cyclohexanedicarboxylic esters, phthalic esters, triglycerides and trialkylphosphoric esters are generally preferred on account of their ready availability and compatibility with the compositions generally cured. A particularly preferred hydrophobic core material is diisononyl 1,2-cyclohexanedicarboxylate.

In general the acrylic copolymer is constructed of units of
(i) 50 to 90 wt %, preferably 55 to 80 wt %, of at least one monomer selected from C₁-C₂₄ alkyl esters of acrylic acid, C₁-C₂₄ alkyl esters of methacrylic acid and vinylaromatics,
(ii) 5 to 20 wt %, preferably 10 to 15 wt %, of at least one monomer which has at least two ethylenic unsaturations, and
(iii) 0 to 30 wt %, preferably 0 to 20 wt %, of one or more other monomers, based in each case on the total weight of the monomers.

Suitable monomers (i) are C₁-C₂₄ alkyl esters of acrylic and/or methacrylic acid. Suitable monomers (b) are isopropyl, isobutyl, sec-butyl and tert-butyl acrylate and the corresponding methacrylates, and also, more preferably, methyl, ethyl, n-propyl and n-butyl acrylate and the corresponding methacrylates. In general, the methacrylates are preferred. Further suitable monomers (i) are vinylaromatics, such as styrene or α-methylstyrene.

In certain embodiments the monomers (i) comprise a combination of at least one monomer that after the polymerization reaction has a glass transition temperature Tg of 70° C. or more with at least one monomer that after polymerization reaction has a glass transition temperature Tg of 50° C. or less. A preferred monomer that after the polymerization reaction has a glass transition temperature Tg of 70° C. or more is methyl methacrylate; a preferred monomer that after the polymerization reaction hasa glass transition temperature Tg of 50° C. or less is n-butyl acrylate or n-butyl methacrylate.

Monomers (ii) have at least two ethylenic unsaturations. They bring about crosslinking of the capsule shell during the polymerization, and give the capsule shell mechanical stability. Suitable monomers (ii) are ethylenically unsaturated monomers which have two, three, four or more nonconjugated ethylenic unsaturations. Preference is given to using monomers having vinyl, allyl, acrylic and/or methacrylic groups. Preferred monomers are those which are insoluble or sparingly soluble in water but have good to limited solubility in the lipophilic substance. Sparing solubility refers to a solubility of less than 60 g/l at 20° C.

Suitable monomers having two ethylenic unsaturations are divinylbenzene and divinylcyclohexane, the diesters of diols with acrylic acid or methacrylic acid, and also the diallyl and divinyl ethers of these diols. Examples include ethanediol diacrylate, ethylene glycol dimethacrylate, 1,3-butylene glycol dimethacrylate, methallylmethacrylamide, allyl acrylate and allyl methacrylate. Particularly preferred are propanediol, butanediol, pentanediol and hexanediol diacrylates and the corresponding methacrylates.

Preferred monomers having three, four or more nonconjugated ethylenic unsaturations are the esters of multiple alcohols with acrylic acid and/or methacrylic acid, and also the allyl and vinyl ethers of these multiple alcohols, trivinylbenzene and trivinylcyclohexane. Multiple alcohols that may be mentioned include, in particular, trimethylol and pentaerythritol. Particularly preferred are trimethylolpropane triacrylate and trimethacrylate, pentaerythritol triallyl ether, pentaerythritol tetraallyl ether, pentaerythritol triacrylate and pentaerythritol tetraacrylate, and also their technical mixtures. Thus pentaerythritol tetraacrylate is generally, in technical mixtures, in a mixture with pentaerythritol triacrylate and minor amounts of oligomerization products.

Particularly preferred monomers (ii) are 1,4-butanediol diacrylate, pentaerythritol triacrylate, pentaerythritol tetraacrylate and triethylene glycol dimethacrylate.

Optional monomers (iii) contemplated are other monomers, different from the monomers (a) to (c), such as vinyl acetate, vinyl propionate, vinylpyridine, acrylic acid, methacrylic acid, maleic acid, itaconic acid, vinylphosphonic acid, maleic anhydride, 2-hydroxyethyl acrylate and methacrylate, acrylamido-2-methylpropanesulphonic acid, methacrylonitrile, acrylonitrile, methacrylamide, N-vinylpyrrolidone, N-methylolacrylamide, N-methylolmethacrylamide, dimethylaminoethyl methacrylate and diethylaminoethyl methacrylate.

The acrylic copolymer is obtainable in a variety of ways, but is obtained preferably by free radical suspension polymerization in an oil-in-water emulsion or water-in-oil emulsion. The choice between an oil-in-water or water-in-oil regime will be made by the skilled person according to the hydrophilicity or lipophilicity of the catalyst to be encapsulated.

One method for free radical suspension polymerization in a water-in-oil emulsion is described in WO 2013/092158 and WO 2014/198531, for example, which are referenced in their entirety.

The microcapsules are preferably obtainable by polymerization of a monomer mixture constituting the capsule shell in the oil phase of a stable oil-in-water emulsion, the oil phase consisting of a hydrophobic material which comprises a polymerization catalyst. This production method is known per se and described in DE 4321205 or WO 2014/127951, for example.

The core of the microcapsules is formed by a hydrophobic material which is emulsifiable in water. The hydrophobic material serves simultaneously as solvent or dispersant for the monomer mixture used in the production of the capsule shells by polymerization. The polymerization then takes place in the oil phase of a stable oil-in-water emulsion. This emulsion is obtained by, for example, first dissolving the monomers and the polymerization initiator and also, optionally, a chain transfer agent in the hydrophobic material, and emulsifying the resulting solution in an aqueous medium containing an emulsifier and/or protective colloid. An alternative possibility is first to emulsify the hydrophobic phase or constituents thereof in the aqueous phase and then to add the monomers or the polymerization initiator and also the auxiliaries still to be used, optionally, such as protective colloids or chain transfer agents, to the emulsion. In another variant of the method, the hydrophobic material and the monomers can also be emulsified in water and then just the polymerization initiator added. Since the hydrophobic material is to be microencapsulated as fully as possible in the emulsion, the hydrophobic materials employed are preferably only those having limited solubility in water. The solubility ought preferably not to exceed 5 wt % at 25° C. For complete encapsulation of the hydrophobic material in the oil phase of the oil-in-water emulsion, it is useful to select the monomers in accordance with their solubility in the hydrophobic material. Whereas the monomers are substantially soluble in the oil, they produce, on polymerization in the individual oil droplets, oligomers and subsequently polymers which are soluble neither in the oil phase nor in the water phase of the oil-in-water emulsion, and which migrate to the interface between the oil droplets and the water phase. There, in the course of the further polymerization, they form the wall material, which ultimately envelopes the hydrophobic material as the core of the microcapsules.

In order to form a stable oil-in-water emulsion, it is usual to use protective colloids and/or Pickering stabilizers as well. Both protective colloids and Pickering stabilizers may be ionic or neutral. Protective colloids and Pickering stabilizers may be used either individually or in mixtures of two or more representatives with identical or different charge.

Protective colloids are preferably water-soluble polymers which lower the surface tension of the water from a maximum of 73 mN/m to 45 to 70 mN/m and thus ensure the formation of closed capsule walls.

Anionic protective colloids are sodium alginate, polymethacrylic acid and copolymers thereof, the copolymers of sulphoethyl acrylate and methacrylate, of sulphopropyl acrylate and methacrylate, of N-(sulphoethyl)maleimide, of 2-acrylamido-2-alkylsulphonic acids, styrene sulphonic acid and also of vinylsulphonic acid. Preferred anionic protective colloids are naphthalenesulphonic acid and naphthalenesulphonic acid-formaldehyde condensates and also, in particular, polyacrylic acids and phenolsulphonic acid-formaldehyde condensates.

Neutral protective colloids are, for example, cellulose derivatives such as hydroxyethylcellulose, methylhydroxyethylcellulose, methylcellulose and carboxymethylcellulose, polyvinylpyrrolidone, copolymers of vinylpyrrolidone, gelatin, gum arabic, xanthan, casein, polyethylene glycols, polyvinyl alcohol and partially hydrolysed polyvinyl acetates and also methylhydroxypropylcellulose.

Preferred neutral protective colloids are polyvinyl alcohol and partially hydrolysed polyvinyl acetates and also methylhydroxy-(C₁-C₄)-alkylcellulose.

Pickering stabilizers are inorganic solid particles. A Pickering system of this kind may consist of the solid particles alone or additionally of auxiliaries which enhance the dispersibility of the particles in water or enhance the wettability of the particles by the lipophilic phase. The mode of action and deployment thereof are described in EP-A-1 029 018 and also EP-A-1 321 182, whose content is expressly incorporated by reference.

The inorganic solid particles may be metal salts, such as salts, oxides and hydroxides of calcium, magnesium, iron, zinc, nickel, titanium, aluminium, silicon, barium and manganese. They include magnesium hydroxide, magnesium carbonate, magnesium oxide, calcium oxalate, calcium carbonate, barium carbonate, barium sulphate, titanium dioxide, aluminium oxide, aluminium hydroxide and zinc sulphide. Silicates, bentonite, hydroxyapatite and hydrotalcites may likewise be mentioned. Particularly preferred are SiO₂-based silicas, magnesium pyrophosphate and tricalcium phosphate.

Suitable SiO₂-based Pickering stabilizers are finely divided silicas. They can be dispersed as fine, solid particles in water. It is also possible, however, to use what are called colloidal dispersions of silica in water. Such colloidal dispersions are alkaline, aqueous mixtures of silica. In the alkaline pH range, the particles are swollen and are stable in water. For these dispersions to be used as Pickering stabilizers, it is advantageous if the pH of the oil-in-water emulsion is adjusted with an acid to a pH of 2 to 7. Preferred colloidal dispersions of silica have, at a pH of 9.3, a specific surface area in the range from 70 to 90 m²/g.

Preferred SiO₂-based Pickering stabilizers are finely divided silicas whose average particle sizes are in the range from 40 to 150 nm at pH levels in the range from 8 to 11. Examples include Levasil® 50/50 (H. C. Starck), Kostrosol® 3550 (CWK Bad Kostritz) and Bindzil® 50/80 (Akzo Nobel Chemicals).

The polymerization takes place in general in the presence of radical-forming polymerization initiators. For this purpose, it is possible to use all customary peroxo compounds and azo compounds in the amounts customarily employed, of 0.1 to 5 wt %, for example, based on the weight of the monomers to be polymerized. Preferred polymerization initiators are those which are soluble in the oil phase or in the monomers. Examples of such are t-butyl peroxyneodecanoate, t-butyl peroxypivalate, t-amyl peroxypivalate, dilauroyl peroxide, t-amyl peroxy-2-ethylhexanoate and the like.

The polymerization of the oil-in-water emulsion is carried out customarily at 20 to 100° C., preferably at 40 to 90° C. The polymerization is customarily performed under atmospheric pressure, but may also take place under reduced or increased pressure, in the range from 0.5 to 20 bar, for example. A useful procedure is to emulsify a mixture of water, protective colloid and hydrophobic materials, polymerization initiators and monomers to the desired droplet size of the hydrophobic material, using a high-speed disperser, and to heat the stable emulsion with stirring to the decomposition temperature of the polymerization initiator. The rate of the polymerization in this case can be controlled through the choice of the temperature and the quantity of the polymerization initiator, in a known manner. When the polymerization temperature is reached, it is useful to continue the polymerization for some further time, such as 2 to 6 hours, for example, in order to complete the conversion of the monomers.

In a particularly preferred operation, the temperature of the polymerizing reaction mixture is raised continuously or periodically during the polymerization. This is done by means of a programme with ascending temperature. For this purpose, the overall polymerization time can be subdivided into 2 or more periods. The first polymerization period is marked by slow decomposition of the polymerization initiator. In the second polymerization period and any further polymerization periods, the temperature of the reaction mixture is raised in order to accelerate the decomposition of the polymerization initiators. The temperature may be raised in one step or in two or more steps or continuously in a linear or nonlinear manner. The temperature difference between the start and the end of the polymerization may be up to 50° C. In general, this difference is 3 to 40° C., preferably 3 to 30° C. After the end of polymerization, the microcapsule dispersion is cooled to room temperature.

If the microcapsule dispersion is to be stored for a relatively long time, it is possible to add thickeners, such as Rheovis® AS 1125, Rheovis® AT 120, Rheovis® AS 1130 (available from BASF SE, Germany) or xanthan, in order to stabilize the suspension and prevent creaming.

The microcapsule dispersions obtained by the procedure outlined above can be dried, for example spray-dried in a customary way. Typically a powder is obtained wherein the remaining water content is less than 5 wt.-%, preferably less than 3 wt.-%, based on the total weight of the powder. To facilitate the redispersing of the spray-dried microcapsules, it is possible, optionally, for additional quantities of emulsifier and/or protective colloid to be added to the dispersions prior to spray drying. The spray drying of the microcapsule dispersion may take place in a customary way. In general, the procedure involves the entry temperature of the drying gas, generally nitrogen or air, being in the range from 100 to 200° C., preferably 120 to 160° C., and the exit temperature of the drying gas being in the range from 30 to 90° C., preferably 60 to 80° C. The spraying of the aqueous microcapsule dispersion in the stream of drying gas may take place, for example, by means of single-fluid or multi-fluid nozzles or via a rotating disc. The microcapsule dispersion is fed in customarily in the range from 2 to 200 bar. The use of a single-fluid nozzle with swirl generator is advantageous. Via the selection of the swirl generator it is possible additionally to influence droplet size and spraying angle. For example, single-fluid nozzles from Delavan can be used that have a typical construction consisting of swirl chamber, which influences the spraying angle, and perforated plate, which influences the throughput.

The particulate microcapsule composition is normally deposited using cyclones or filter separators. The sprayed aqueous microcapsule dispersion and the stream of drying gas are preferably guided in parallel. The drying gas stream is preferably blown from above into the tower cocurrently with the microcapsule dispersion.

According to one process variant it is possible to insert a fluidized bed downstream of the dryer, in order to remove any residual moisture. Processes where spray drying is followed by fluidized bed drying are preferred, since they lead to a microcapsule composition having a smaller fines fraction.

The proportion of the catalyst (c) here is preferably from 0.05 to 10% by weight, particularly preferably from 0.1 to 5% by weight, and in particular from 0.1 to 2.5% by weight, based on the total weight of components (b) to (d). The manner of use of the catalyst here is preferably such that the gel time of the polyurethane reaction mixture of the invention is greater than 10 minutes at 23° C., after mixing of components (a) to (d), more preferable greater than 15 minutes and particularly preferably greater than 20 minutes and smaller than 60 minutes, and in particular greater than 15 minutes and smaller than 60 minutes. The selection of the catalyst preferably is such that complete hardening of the polyurethane reaction mixture of the invention takes place at higher temperature, preferably above 100° C., most preferable above 150° C., and in particular between 200° C. and 240° C. For example, at 220° C. the hardening take place within 60 seconds after mixing of components (a) to (d), more preferably from 0 to 45 seconds, particularly from 5 to 35 seconds and in particular from 5 to 30 seconds. In a preferred embodiment, in addition to the encapsulated catalyst further polyurethane catalysts may be added as long as the gel time of the polyurethane reaction mixture of the invention is greater than 10 minutes at 23° C. These additional catalysts may be blocked amine catalysts as 1,8-diazabicyclo[5.4.0]undec-7-ene blocked with carboxylic acid. In a more preferred embodiment the catalyst (c) is consisting of the microencapsulated polyurethane catalyst and no further polyurethane catalyst is added.

For determining the gel time at 23° C. here, the components for producing the polyurethane reaction mixture are weighed into a beaker at room temperature and mixed with one another at 2000 revolutions per minute for 30 seconds in a high-speed mixer. 100 g of the entire system are then weighed into a separate beaker, and the gel time is determined with the aid of a wooden spatula. The gel time corresponds to the time difference between the start of the mixing process and hardening, i.e. initial formation of clumps.

For determination of full hardening at temperatures above 120° C., the components for producing the polyurethane reaction mixture are weighed into a beaker at room temperature and mixed with one another at 2000 revolutions per minute for 30 seconds in a high-speed mixer. 10 mL of the system are placed inside a 0 10 cm metal ring on a plate with surface temperature of 120° C., with the aid of a Pasteur pipette. The time (in s) when the reactive mixture starts to harden at the inner border of the ring is defined as the start time, the time when the reactive mixture no longer adheres to a wooden spatula is defined as the end time of curing.

Further additives (d) used can comprise any of the additives known for producing polyurethanes. Examples that may be mentioned are surfactant substances, release agents, coupling agents, fillers, dyes, pigments, flame retardants, hydrolysis stabilizers, viscosity reducers, water scavengers, antifoaming agents, and also substances having fungistatic and bacteriostatic action. Substances of this type are known and are described by way of example in “Polyurethane Handbook, 2^{nd} edition, Hanser Publishers, 1993, chapter 3.4.4 and 3.4.6 to 3.4.11.

Examples of additives that can be used for water adsorption are therefore aluminosilicates, selected from the group of the sodium aluminosilicates, potassium aluminosilicates, calcium silicates, cesium aluminosilicates, barium aluminosilicates, magnesium aluminosilicates, strontium aluminosilicates, sodium aluminophosphates, potassium aluminophosphates, calcium aluminophosphates, and mixtures thereof. It is particularly preferable to use mixtures of sodium aluminosilicates, potassium aluminosilicates, and calcium aluminosilicates in castor oil as carrier substance.

The number-average particle size of the water-absorption additive is preferably not greater than 200 μm, particularly preferably not greater than 150 μm, and in particular not greater than 100 μm. The pore width of the water-absorption additive of the invention is preferably from 2 to 5 Ångstroem.

If a water-absorption additive is added, the amounts here are preferably greater than one part by weight, particularly preferably in the range from 0.5 to 5 parts by weight, based on the total weight of components (b) to (d).

Coupling agents that can be used comprise silanes, such as isocyanate silanes, epoxysilanes, or aminosilanes. Substances of this type are described by way of example in E. P. Plueddemann, Silane Coupling Agents, 2nd ed., Plenum Press, New York, 1991 and in K. L. Mittal, ed., Silanes and Other Coupling Agents, VSP, Utrecht, 1992.

Internal release agents that can be used are any of the conventional release agents used in producing polyurethanes, examples being long-chain carboxylic acids, in particular fatty acids, such as stearic acid, amines of long-chain carboxylic acids, e.g. stearamide, fatty acid esters, metal salts of long-chain carboxylic acids, e.g. zinc stearate, or silicones. Particularly suitable materials are the internal release agents obtainable specifically for the pultrusion process, e.g. from Axel Plastics or Technick Products. The internal release agents from Technick Products probably comprise phosphoric acid and fatty acids. The internal release agents from Axel Plastics probably comprise fatty acids.

Examples of viscosity reducers that can be used are γ-butyrolactone, propylene carbonate, and also reactive diluents, such as dipropylene glycol, diethylene glycol, and tripropylene glycol.

The polyurethane resin of the invention preferably comprises less than 2% by weight, particularly preferably less than 1% by weight, of substances which have a boiling point below 200° C. at standard pressure. The viscosity of the polyurethane resin system at 25° C. to DIN 53019-1 to 3 immediately after mixing of components (a) to (d) is preferably smaller than 1500 mPas, particularly preferably smaller than 1200 mPas, and in particular smaller than 1000 mPas. The quantitative proportions in which components (a) to (d) are mixed here is preferably such that the isocyanate index is from 90 to 140, particularly preferably from 100 to 130, and in particular from 115 to 125. For the purposes of the present invention, the isocyanate index here is the stoichiometric ratio of isocyanate groups to groups reactive toward isocyanate, multiplied by 100. Groups reactive toward isocyanate here are any of the groups comprised within the reaction mixture that are reactive toward isocyanate, but not the isocyanate group itself.

The present invention also provides a process for producing a polyurethane reinforced composite. In this process, the components of a polyurethane resin system of the invention are mixed to give a polyurethane reaction mixture, and the resultant reaction mixture is used to wet the reinforcing material, for example the fiber material, at temperatures below 100° C., preferably at 0 to 75° C., more preferably at 10 to 50° C. and particularly at 15 to 35° C. Preferably prior to the formation of the reaction mixture components (b) to (d) are mixed to give one polyol component (B) which is then mixed with the isocyanate component (A) comprising the isocyanates (A).

Preferably isocyanate component (A) does not comprise any catalysts (c) and more preferably is consisting of isocyanates (a) only.

For the filament winding process the wetted fiber material is then wound under tension over a rotating mandrel. Once the mandrel is completely covered to the desired thickness, the resin is cured. For the pultrusion process the wetted fiber material is molded in a heated die, and the reaction mixture is hardened, preferably during passage of the heated die.

For the purposes of this invention, the mixture of components (a) to (d) is termed reaction mixture when conversions in the reaction are smaller than 90%, with respect to the isocyanate groups.

The mixing of the components of the polyurethane reaction mixture of the invention here can take place in a manner conventional for producing polyurethane-based reaction mixtures, for example in the high-pressure or low-pressure process.

The reinforcing material can be any reinforcing material known in the field of polyurethanes. This comprises honeycomb material, as cardboard-honeycomb material and fiber material. Fiber material used according to the invention can comprise any of the types of fiber material, preferably any kind of continuous-filament fibers. Continuous-filament fiber here means a fiber material the length of which is at least a plurality of meters. These materials are by way of example unwound from rolls. The fiber material used here can comprise individual fibers, known as fiber rovings, braided fibers, fiber mats, fiber scrims, and woven fibers. Particularly in the case of fiber composites, such as braided fibers, twisted fibers, fiber scrims, or woven fibers, there can also be shorter individual fibers comprised within the individual fibers comprised within said fiber structures, but the fiber composite itself must take the form of a continuous-filament material. It is preferable that the fiber material comprises or is composed of glass fiber, glass mats, carbon fiber, polyester fiber, natural fiber, aramid fiber, basalt fiber, or nylon fiber, and it is particularly preferable to use carbon fibers or glass fibers.

The wetting of the fiber material here can take place in an open die or preferably in a closed die. The temperature during wetting of the fiber material is preferably below 100° C., preferably from 0 to 75° C., particularly preferably from 10 to 50° C., and in particular from 15 to 35° C. The proportion of fiber material here is preferably from 10 to 90% by weight, particularly preferably from 30 to 90% by weight, in particular from 60 to 90% by weight, based on the finished pultrudate.

For the pultrusion process according to the invention, after the wetting process, the fiber material wetted with the reaction mixture is preferably drawn through a die. This die can have any desired cross-sectional shape, perpendicularly with respect to the direction of draw of the wetted fiber material, but this shape is preferably as constant as possible, for example slot-shaped or circular, or L-shaped or T-shaped, or else of a more complex shape. The temperature of this die is preferably from 100 to 250° C., most preferably between 150 and 230° C., and the polyurethane reaction mixture therefore hardens to give the finished polyurethane.

It is preferable that the pultrudate is drawn out of the die at a speed of more than one meter per minute. The take-off speed is particularly preferably more than 1.5 meters per minute and in particular more than 2.0 meters per minute. The resultant pultrudate is usually cut to the desired length. In a particular preferred embodiment the pultrudate has a cross section which is different from a flat section, as L-shape, V-shape or U-shape profiles, or profiles with even higher complexity.

The present invention also provides a pultrudate, obtainable by the process of the invention. This pultrudate has excellent surface quality and quality of wetting. The mechanical properties of the pultrudates are identical for take-off speeds of 0.5 m/min and take-off speeds of 1.5 m/min. In addition, the polyol component is storage stable for more than one month, preferably for more than two months.

Examples will be used below to illustrate the invention:

The following materials were used:

| | |
|---|---|
| Polyol 1 | glycerol initiated propylenoxide having an OH-value |
| | of 400 mg KOH/g |
| Polyol 2 | glycerol initiated propylenoxide/polyethylenoxid having |
| | an OH-value of 42 mg KOH/g |
| Polyol 3 | glycerol initiated propylenoxide having an OH-value of |
| | 805 mg KOH/g |
| Kat 1 | Tinstab OTS 16 OCTYLTINMERCAPTIDE |
| Kat 2 | Polycat SA 1/10 mit 1,8-Diaza-bicyclo(5.4.0)undec-7-ene |
| | blocked with phenole (molar ratio 1:1) |
| Kat 3 | DBTL (Dibutyltindilaurat) |
| Kat 4 | encapsulated DBTL contain 40% by weight of pure DBTL |
| IMR 1 | Internal mold release agent, |
| IMR 2 | Internal mould release agent |
| Iso 1 | Lupranat polymeric MDI with an average functionality of |
| | 2.7; NCO cont. 31.5 g/100 g |
| Iso 2 | Mixture of 2,4′- and 4,4′-diphenylmethane diisocyanate; |
| | NCO content 33.,5 g/100 g |

Production of Kat. 4:

Water Phase:

171.9 g DI water (DI=fully deionized water)

36 g of a 50% by weight silica sol in water (specific surface area ca. 80 m²/g) 1.68 g of a 5% by weight aqueous solution of methylhydroxypropylcellulose with an average molecular weight of 26 000 g/mol

0.48 g of a 2.5% by weight aqueous sodium nitrite solution

0.60 g of a 20% by weight nitric acid solution in water

### Feed 1

96 g dibutyl-tin-dilaurate

19.2 g methyl methacrylate

2.4 g n-butyl acrylate

2.4 g pentaerythritol triacrylate

### Feed 2:

0.25 g tert.-butyl peroxoneodecanoate (97% purity)

### Feed 3:

2.4 g of a 10% strength by weight aqueous solution of tert.-butyl hydroxoperoxide

### Feed 4:

0.48 g of ascorbic acid dissolved in 20 g of DI water

The water phase above was introduced at 25° C. Feed 1 was added and the mixture was dispersed with a high-speed dissolver stirrer at 21000 rpm. 3 minutes of dispersion gave a stable emulsion. Following the introduction of feed 2, the reaction batch was subjected to the following temperature program: heating to 55° C. in 60 minutes, heating to 80° C. in 60 minutes, holding of this temperature for 60 minutes. Feed 3 was added and, in the course of cooling to 20° C., feed 4 was run in over the course of 60 minutes. Subsequently, the batch was stirred for another 30 minutes.

This gave a dispersion having a solids content of 42.2% by weight with an average particle size (D0.5) of 4.13 μm (z-average determined by means of light scattering).

Subsequently, the dispersion was freeze-dried to remove the water, resulting in an off-white powder.

The particle size distribution of the microcapsules was measured using a Malvern Mastersizer 2000, Hydro 2000S sample dispersion unit, with standard measurement methods, which are documented in the literature. The specified value is the average value i.e. D(0,5).

For freeze drying, the samples were frozen on dry ice in a metal tray having a depth of 25 mm. Drying takes place at 1.013 mbar in a Christ Alpha 2-4 freeze dryer with LDC-1M temperature controller. The sample temperature was regulated at −20° C. The temperature of the ice condenser was <−60° C. The drying operation was ended when the temperature both of the sample and of the substrate was <0° C. The drying time is dependent on the quantity and physical nature of the material being dried. After drying has been carried out, the apparatus is aerated with ambient air and the samples are scraped from the mould using a spatula and dispensed.

According to table 1 an Isocyanate component (A) and a polyolcomponent (B) were produced and reacted at an isocyanate index of 121. Gel time at 23° C. and full hardening at 120° C. were determined. For determining the gel time here, the components for producing the polyurethane reaction mixture are weighed into a beaker at room temperature and mixed with one another at 2000 revolutions per minute for 30 seconds in a high-speed mixer. 100 g of the entire system are then weighed into a separate beaker, and the gel time is determined with the aid of a wooden spatula. The gel time corresponds to the time difference between the start of the mixing process and hardening, i.e. initial formation of clumps.

For determination of full hardening at 120° C., the components for producing the polyurethane reaction mixture are weighed into a beaker at room temperature and mixed with one another at 2000 revolutions per minute for 30 seconds in a high-speed mixer. 10 mL of the system are placed inside a [symbol] 10 cm metal ring on a plate with surface temperature 120° C., with the aid of a Pasteur pipette. The time (in s) between application to the plate and beginning of hardening at the inner border of the ring is defined as “Full Hardening start”, the time when the reactive mixture no longer adheres to a wooden spatula is defined as the end time of curing.

TABLE 1

| | C1 | E1 | C2 | C3 | C4 | E2 | C5 | E3 |
|---|---|---|---|---|---|---|---|---|
| Polyol 1 | 45.9 | 45.9 | 45.9 | 45.9 | 45.9 | 45.9 | 45.9 | 45.9 |
| Polyol 2 | 4.5 | 4.5 | 4.5 | 4.5 | 4.5 | 4.5 | 4.5 | 4.5 |
| Polyol 3 | 44.5 | 44.5 | 44.5 | 44.5 | 44.5 | 44.5 | 44.5 | 44.5 |
| Kat 1 | | | | | | | 1.4 | |
| Kat 2 | | | | 0.1 | | | | |
| Kat 3 | | | | | 0.010 | | | |
| Kat 4 | | 0.25 | | | | 0.25 | | 0.25 |
| Kat 5 | | | | | | | | |
| Kat 6 | | | | | | | | |
| IMR 1 | | | | | | | 5.0 | 5.0 |
| IMR 2 | | | 5.0 | 5.0 | 5.0 | 5.0 | | |
| Sum | 94.9 | 95.2 | 99.9 | 100.0 | 99.9 | 100.2 | 101.3 | 100.2 |
| Iso 1 | 50.0 | 50.0 | 50.0 | 50.0 | 50.0 | 50.0 | 50.0 | 50.0 |
| Iso 2 | 50.0 | 50.0 | 50.0 | 50.0 | 50.0 | 50.0 | 50.0 | 50.0 |
| Sum | 100.0 | 100.0 | 100.0 | 100.0 | 100.0 | 100.0 | 100.0 | 100.0 |
| Index | 121 | 121 | 121 | 121 | 121 | 121 | 121 | 121 |
| GT at 23° C. | 33:52 | 34:16 | 11:22 | 7:45 | 5:30 | 10:55 | 13:37 | 20:45 |
| [mm:ss] | | | | | | | | |
| FH at 120° C.; | 2:20 | 0:49 | 0:45 | 0:12 | 0:24 | 0:26 | 0:39 | 0:48 |
| start [mm:ss] | | | | | | | | |
| FH at 120° C.; | 3:02 | 1:48 | 1:23 | 0:50 | 1:02 | 1:09 | 1:17 | 1:49 |
| end [mm:ss] | | | | | | | | |

GT: gel time
FH: open time

The polyurethane obtained according to table 1 was characterized in table 2:

TABLE 2

| | C2 | C3 | C4 | E2 | C5 | E3 |
|---|---|---|---|---|---|---|
| Hardness | 85 | 84 | 86 | 85 | 85 | 83 |
| Tensile | 127.1 | 129.3 | 125.5 | 134.6 | 129.8 | 124.7 |
| strength | | | | | | |
| E-modulus | 2838 | 2938 | 2848 | 2873 | 2919 | 2701 |
| Elongation | 5.2 | 10.5 | 6.1 | 10.1 | 11.1 | 9.3 |
| at break | | | | | | |
| Bending | 75.1 | 87.7 | 79.4 | 90.2 | 87.5 | 81.7 |
| strength | | | | | | |
| Bending | 3007 | 3150 | 3097 | 3065 | 3108 | 3108 |
| E-modulus | | | | | | |
| Tg, max G″ | 105 | 110 | 100 | 110 | 95 | 95 |

The values in table 2 were determined as follows:

Hardness (Shore D) according to DIN 53505

Tensile Strength (N/mm²) according to DIN 53504

E-modulus (MPa) according to DIN EN ISO 527

Elongation at break (%) according to DIN EN ISO 527

Bending Strength (N/mm²) according to DIN EN ISO 178

Bending E-modulus (MPa) according to DIN EN ISO 178

Glass temperature Tg (° C.) according to DIN EN ISO 179

Storage stability for examples 1, 2 and 3 is shown in table 3:

TABLE 3

| open time at | | | | | |
|---|---|---|---|---|---|
| different temp. | | | | | |
| [min:s] | fresh | 7 days | 14 days | 1 month | 2 months |
| | example 2 | | | | |
| GT at 23° C. | 10:55 | 11:34 | 11:10 | 11:00 | 11:00 |
| FH at 120° C. | 00:26 | 00:29 | 00:29 | 00:28 | 00:28 |
| Start | | | | | |
| FH at 120° C. | 01:09 | 01:10 | 01:10 | 01:12 | 01:10 |
| End | | | | | |
| | example 3 | | | | |
| GT at 23° C. | 20:45 | 20:48 | 18:59 | 19:05 | 19:27 |
| FH at 120° C. | 00:48 | 00:55 | 00:51 | 00:54 | 00:57 |
| Start | | | | | |
| FH at 120° C. | 01:49 | 01:44 | 01:47 | 01:45 | 01:51 |
| End | | | | | |
| | example 1 | | | | |
| GT at 23° C. | 34:16 | 32:42 | 34:24 | (41:47) | 35:56 |
| FH at 120° C. | 00:47 | 00:52 | 00:51 | 00:51 | 00:58 |
| Start | | | | | |
| FH at 120° C. | 01:48 | 01:47 | 01:51 | 01:51 | 02:05 |
| End | | | | | |

Table 3 shows that the reactivity after storage dos not change from reactivity of a fresh sample.

1. A Process for the production of a polyurethane reinforced composite comprising mixing a
A) a Polyisocyanate component comprising di- or Polyisocyanates (a) and
B) a polyol component comprising
b) compounds having at least two groups reactive toward isocyanates,
c) catalyst,
d) optionally further additives,
to form a polyurethane reaction mixture,
contacting the reaction mixture with the reinforcing material at temperatures of less than 100° C. and curing the reaction mixture at temperatures of more than 100° C. to form a polyurethane reinforced composite,
wherein the catalyst (c) comprises microencapsulated polyurethane catalyst which comprises a capsule core, containing polyurethane catalyst, and an acrylic copolymer capsule shell and wherein the average particle size D(0,5) of the microcapsules is 1 to 50 μm.

2. The Process according to claim 1, characterized in that the polyurethane reinforced composite is a polyurethane fiber reinforced composite.

3. The process according to claim 1, wherein the polyurethane catalyst is selected from the group, consisting of dibutyltin dilaurate, dioctyltin dilaurate, bismuth neodecanoate, bismuth dioctoate and bismuth ethylhexanoate or mixtures of two or more thereof.

4. The process according to claim 1, wherein the capsule core of the catalyst (c) comprises a hydrophobic core material as well as the polyurethane catalyst.

5. The process according to claim 1, wherein the acrylic copolymer is constructed of units of
(i) 50 to 90 wt.-% of at least one monomer selected from C₁-C₂₄ alkyl esters of acrylic acid, C₁-C₂₄ alkyl esters of methacrylic acid and vinylaromatics,
(ii) 5 to 20 wt.-%, of at least one monomer which has at least two ethylenic unsaturations, and
(iii) 0 to 30 wt.-%, of one or more other monomers, based in each case on the total weight of the monomers.

6. The process according to claim 1, wherein the monomers (i) comprise a combination of at least one monomer that after polymerization has a glass transition temperature Tg of 70° C. or more with at least one monomer that after polymerization has a glass transition temperature Tg of 50° C. or less.

7. The process according to claim 1, wherein the di- and polyisocyanates (a) used comprise polymeric MDI having an average functionality of from 2.1 to 2.8.

8. The process according to claim 1, wherein the compounds (b) having at least two groups reactive toward isocyanates comprise polyetherols having an average functionality of from 2 to 4 and having at least 50% content of secondary OH groups.

9. The process according to claim 1, wherein the average OH number of the compounds (b) having at least two groups reactive toward isocyanates is from 100 to 1000 mg KOH/g.

10. The process according to claim 1, wherein the viscosity of the reaction mixture is smaller than 1500 mPas at 25° C. immediately after mixing of components (a) to (d).

11. The process according to claim 1, wherein less than 2.0% by weight of substances which have a boiling point of less than 200° C. at standard pressure, based on the total weight of the polyurethane reaction mixture, are added to form the polyurethane reaction mixture.

12. The process according to claim 1, wherein the wetted fiber material is drawn through a die and hardened, where the temperature of the die is from 100° C. to 250° C.

13. The process according to claim 1, wherein the take-off speed at which the wetted fiber material is drawn through the die is greater than one meter per minute.

14. The process according to claim 1, wherein the content of fiber material is from 30 to 90% by weight.

15. A polyurethane reinforced composite, capable of production by a process according to claim 11.
